(19) United States
(12) Patent Application Publication
(10) Pub. No.: US 2010/0241912 A1
(43) Pub. Date: Sep. 23, 2010

(54) Fast bit-error rate calculation mode for QKD systems

(75) Inventors: Brandon Kwok, Burlington, MA (US); A. Craig Beal, Watertown, MA (US); Audrius Berzanskis, Cambridge, MA (US); Wensheng Sun, Bradford, MA (US)

Correspondence Address: OPTICUS IP LAW, PLLC, 7791 ALISTER MACKENZIE DRIVE, SARASOTA, FL, 34240, US

(73) Assignee: MAGIQ TECHNOLOGIES, INC.

(21) Appl. No.: 11/397,772

(22) Filed: Apr. 4, 2006

(51) Int. Cl. G06F 11/00

(52) U.S. Cl. 714/704; 714/E11.004; 714/746

(57) ABSTRACT

A fast bit-error rate (F-BER) calculation mode for a QKD system is disclosed, wherein the method includes establishing versions of a sifted key in respective sifted-bits (SB) buffers in respective QKD stations (Alice and Bob). The method also includes sending Alice's version of the sifted key to Bob, and Bob performing a comparison of the two sifted key versions. The number of bit errors between the two sifted key versions relative to the length of the sifted key yields the F-BER. The F-BER is calculated much more quickly than the conventional BER calculation (“N-BER”), which involves performing a relatively complex error-correction algorithm. The F-BER calculation mode is particularly useful in quickly setting up and/or calibrating a QKD system, and can be repeated quickly to provide updated BER measurements after each QKD system adjustment.

### TECHNICAL FIELD OF THE INVENTION

The present invention relates to quantum cryptography, and in particular relates to error correction and determining the bit-error rate (BER) in quantum key distribution (QKD) systems.

### BACKGROUND ART

QKD involves establishing a key between a sender (“Alice”) and a receiver (“Bob”) by using either single-photons or weak (e.g., 0.1 photon on average) coherent pulses (WCPs), also called “qubits” or “quantum signals,” transmitted over a “quantum channel.” Unlike classical cryptography whose security depends on computational impracticality, the security of quantum cryptography is based on the quantum mechanical principle that any measurement of a quantum system in an unknown state will modify its state. As a consequence, an eavesdropper (“Eve”) that attempts to intercept or otherwise measure the exchanged qubits will introduce errors that reveal her presence.

The general principles of quantum cryptography were first set forth by Bennett and Brassard in their article “Quantum Cryptography: Public key distribution and coin tossing,” Proceedings of the International Conference on Computers, Systems and Signal Processing, Bangalore, India, 1984, pp. 175-179 (IEEE, New York, 1984). Specific QKD systems are described in U.S. Pat. No. 5,307,410 to Bennett, and in the article by C. H. Bennett entitled “Quantum Cryptography Using Any Two Non-Orthogonal States”, Phys. Rev. Lett. 68 3121 (1992).

The general process for performing QKD is described in the book by Bouwmeester et al., “The Physics of Quantum Information,” Springer-Verlag 2001, in Section 2.3, pages 27-33. The error-correction process is described in general in Bouwmeester in sections 2.3.1 and 2.5.1. The error-correction process involves a complex recursive algorithm that compares blocks and sub-blocks of bits and corrects parity errors until Alice and Bob share a key that is identical to within a certain error tolerance (e.g., one error in 10⁵ bits). This level of error-correction requires a large number of bits, which translates into a large number of exchanged quantum signals. The process of obtaining enough bits to perform the error correction algorithm can take a relatively long time, e.g., on the order of minutes, hours or days, depending on the communication distance, quantum signal strength, etc. Since the bit-error rate (BER) is determined only after the error-correction process has been performed, it takes a relatively long time to establish the BER.

Historically, the time it takes to determine the BER has not been an issue since virtually all QKD systems operating today are laboratory based experimental-type systems. However, the BER is an important parameter useful for other practical aspects of a commercially viable QKD system beyond monitoring the effectiveness of the key exchange process. For example, the BER is an important parameter for QKD system set-up and/or system calibration when the system is initially being deployed or is already deployed in the field. Having to wait for the error-correction process to be completed prior to determining the BER makes the set-up and/or calibration process lengthy and tedious, particularly when a number of adjustments are made to the system each requiring a BER measurement.

### SUMMARY OF THE INVENTION

A first aspect of the invention is a method of calculating a fast bit-error rate (F-BER) in a QKD system that has first and second QKD stations. The method includes establishing first and second versions of a sifted key in respective first and second sifted-bits (SB) buffers in the first and second QKD stations. The method also includes transferring the first version of the sifted key in the first SB buffer in the first QKD station to the second QKD station. The method further includes comparing, at the second QKD station, the first and second versions of the sifted key to identify a number of bit errors relative to the sifted key length to establish the F-BER.

A second aspect of the invention is a method of calculating a fast bit-error rate (F-BER) in a QKD system that has first and second QKD stations. The method includes establishing first and second versions of a sifted key in respective first and second QKD stations. The method also includes sending the first version of the sifted key to the second QKD station and comparing the first and second versions of the sifted key to establish a number of bit errors. The method also includes establishing the F-BER by dividing the number of bit errors by the sifted-key length.

A third aspect of the invention includes switching between an F-BER mode and a normal BER mode (“N-BER” mode). This includes, for example, operating in the F-BER mode in connection with QKD system set-up and/or calibration, and operating in the N-BER mode in connection with running the QKD system in its normal operating mode that involves exchanging quantum signals to establish a quantum key.

### BRIEF DESCRIPTION OF THE DRAWING

FIG. 1 is a schematic diagram of an example QKD system that supports the F-BER calculation mode of the present invention;

FIG. 2 is a flow diagram of the normal BER (N-BER) calculation mode for the QKD system of FIG. 1; and

FIG. 3 is a flow diagram of the fast BER (F-BER) calculation mode of the QKD system of FIG. 1.

The various elements depicted in the drawing are merely representational and are not necessarily drawn to scale. Certain sections thereof may be exaggerated, while others may be minimized. The drawing is intended to illustrate an example embodiment of the invention that can be understood and appropriately carried out by those of ordinary skill in the art.

### DETAILED DESCRIPTION OF THE INVENTION

The present invention is directed to a fast BER (F-BER) calculation mode for a QKD system. In an example embodiment of the present invention, the F-BER mode is used during QKD system set-up and calibration, when the system is not transmitting any user data and absolute security is not a concern. Furthermore, a normal BER (N-BER) calculation mode is used during normal QKD system operation (i.e., when the key exchange process is underway), when the highest level of security is needed. The QKD system switches between the F-BER and N-BER modes as needed. The present invention applies to QKD systems in general, and is not limited to either a so-called “one-way” or to a so-called “two-way” QKD system.

In the description herein, and in the claims below, the term “buffer size” is used to describe the number of bits stored in a given buffer, rather than the storage capacity of a given buffer.

QKD System with N-BER and F-BER Modes

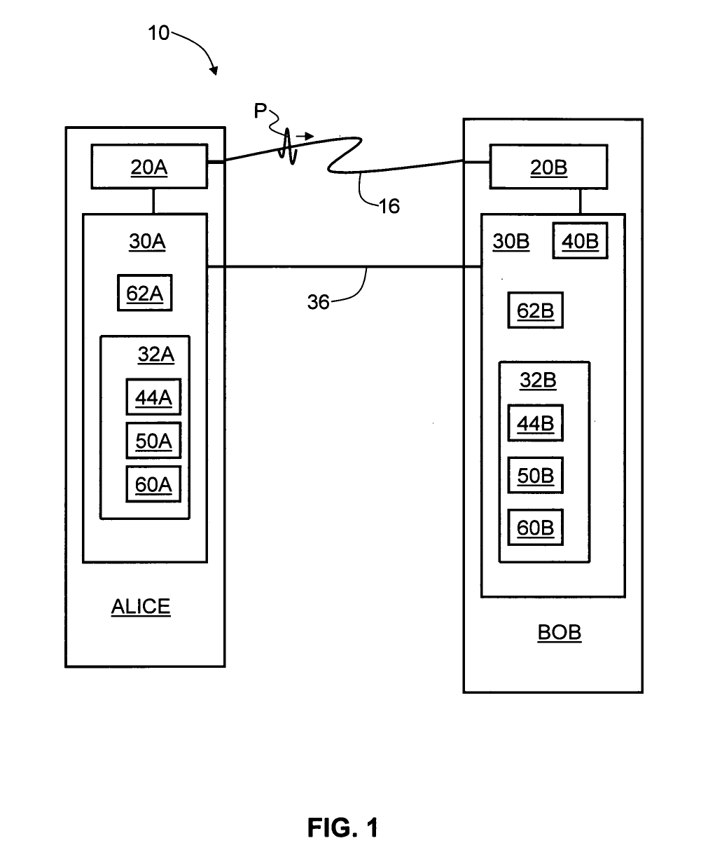

FIG. 1 is a schematic diagram of an example QKD system 10 that supports the F-BER calculation mode of the present invention. QKD system 10 includes two QKD stations Alice and Bob operably coupled by an optical fiber link 16. QKD system 10 is amenable for implementing the F-BER calculation mode of the present invention. Alice and Bob have respective optical layers 20A and 20B each operably coupled to respective electronics/software (E/S) layers 30A and 30B. Optical layers 20A and 20B are optically coupled to one another via an optical fiber link 16. The optical layers 20A and 20B process the single-photon-level optical pulses (“quantum signals”) P sent from Alice to Bob, as well as non-quantum signals, such as optical synchronization signals (not shown). The E/S layers 30A and 30B control the operation of the corresponding optics layers 20A and 20B, and communicate with each other (e.g., via a separate communication link 36, or multiplexed together onto optical fiber link 16) to control the operation of QKD system 10 as a whole. Bob's E/S layer 30B includes a single-photon-detector (SPD) unit 40B adapted to detect quantum signals P sent from Alice to Bob.

In an example embodiment, E/S layers 30A and 30B respectively include, among other elements, memory units 32A and 32B. These memory units respectively include raw-bits (RB) buffers 44A and 44B that store bits that make up a raw key, and sifted-bits (SB) buffers 50A and 50B that store bits that make up a sifted key, as explained below. Memory units 32A and 32B also respectively include error-correction (EC) buffers 60A and 60B that receive and store sifted bits from SB buffers 50A and 50B. When enough sifted bits are transferred to and collected in the EC buffers, they are processed to form the error-corrected key.

In an example embodiment, each E/S layer 30A and 30B includes respective central processing units (CPUs) 62A and 62B adapted to carry out logic operations and other control functions for the respective QKD stations as well as the QKD system as a whole. In an example embodiment, E/S layers 30A and 30B include or are otherwise formed from respective field-programmable gate arrays (FPGAs).

### Calculating N-BER

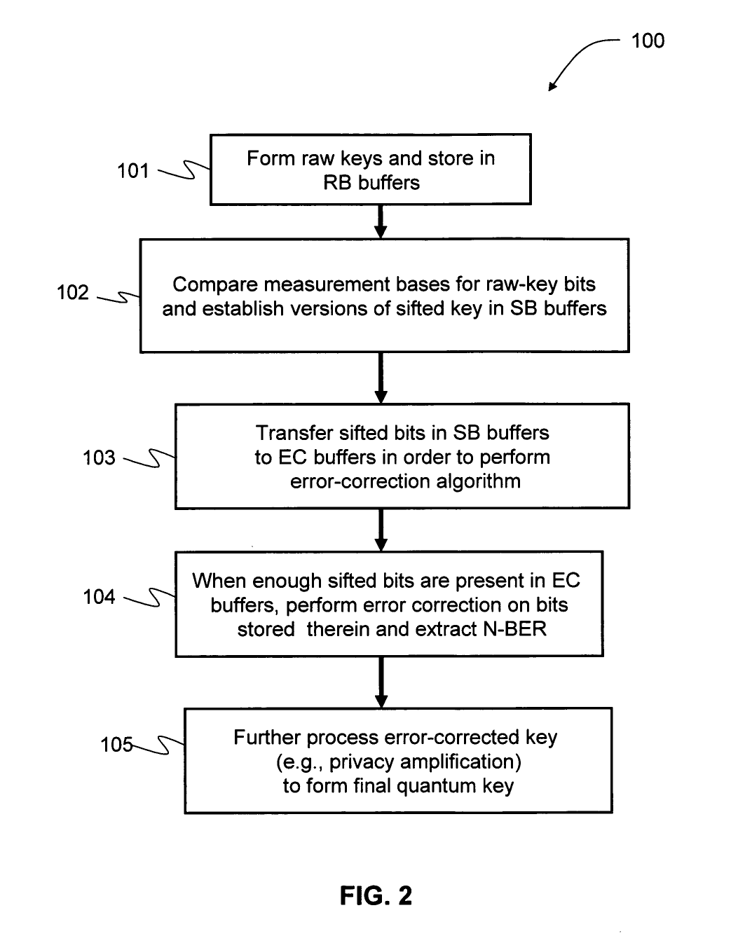

For the sake of illustrating the error-correction process and BER calculation methods, it is assumed that QKD system 10 uses phase encoding. With reference also to flow diagram 100 of FIG. 2, in 101 Alice and Bob establish a raw key between them. This is accomplished by Alice randomly choosing the basis and phase of quantum signals P and sending them to Bob over optical fiber link 16. Alice records the basis and phase of the outgoing quantum signals in RB buffer 44A. Bob measures (encodes) each quantum signal with a random phase, and detects the encoded quantum signal in SPD unit 40B. He then records the measurement for each expected photon time slot in RB buffer 44B. E/S layers 30A and 30B are adapted to correlate buffer addresses associated with a transmitted quantum signal from Alice with an expected arrival time of the quantum signal at Bob.

After a sufficient number of quantum signals are exchanged, Alice and Bob each have stored in RB buffers 44A and 44B two different versions of a set of raw bits that have corresponding transmitted/measured bases. These raw bits form the raw key.

In 102, Alice and Bob form the sifted key from the raw key. This is accomplished by Alice and Bob publicly share their measurement bases for each of the detected quantum signals. Measurements made in the same basis result in perfectly correlated bits that are kept, while measurements made in different bases are discarded. In practice, errors arise due to system imperfections, or due to an eavesdropper trying to measure the quantum signals. Accordingly, even after Alice and Bob compare their measurement bases in an effort to further refine the raw key, they do not yet share exactly the same key (bits). The set of bits remaining after the raw key is processed is called the “sifted key,” different versions of which reside in SB buffers 50A and 50B.

Alice and Bob need to have (virtually) identical quantum keys in order to securely encrypt information. This is accomplished in 103 by transferring sifted bits from SB buffers 50A and 50B to EC buffers 60A and 60B until these larger buffers are filled, and then performing “error correction” on the collection of sifted key bits. As mentioned above, the error correction process typically involves executing a complex algorithm with the assistance of CPU units 62A and 62B of corresponding E/S layers 30A and 30B.

One example error-correction algorithm involves dividing the sifted bits held in EC buffers 60A and 60B at Alice and Bob into respective equal-sized “blocks,” and then checking the bit parity between the blocks. If there is a parity discrepancy, then one of the blocks has an odd number of errors. In this case, the blocks are divided into sub-blocks, searched recursively, and the error identified and corrected to restore parity. This procedure results in the sub-blocks having either an even number of errors or no errors. Alice and Bob then re-shuffle their bits and repeat the procedure with larger block sizes. However, correcting bits at this larger scale introduces errors in the previously checked sub-blocks. Accordingly, the procedure repeats the smaller-block-size step.

This parity-check/error-correction process is repeated until key parity is achieved to within an acceptable error limit. After the error-correction process, in 104 the N-BER is extracted from the error-correction data as a count of the parity bit discrepancies. In 105, the error-corrected key is then further processed (e.g., undergoes privacy amplification) to obtain a final quantum key shared by both Bob and Alice. The final quantum key is then used to encrypt data.

### Calculating F-BER

In a commercial QKD system, the error-correction algorithm relies on obtaining a sufficiently large number of quantum signal counts (e.g., 10⁴ to 10⁵) obtained from SPD unit 40B. For an optical-fiber-based QKD system where the distance between Alice and Bob is relatively long (e.g., on the order of 120 km), the number of useful SPD unit counts tends to be relatively low relative to the number of quantum signals P actually sent (e.g., 1 count per every 100 quantum signals sent) due to fiber losses, noise in the fiber, and other factors. As a result, the time it takes to fill the SB buffers and the EC buffers with the required number of bits is usually relatively lengthy. This significantly slows down the QKD process, including the error-correction process.

When the error-correction process is slow, it adversely affects the QKD system's ability to quickly determine the N-BER of the system. A typical time for calculating the N-BER in a QKD system is on the order of minutes, hours, or even days in the case of a relatively long (e.g., 120 km) optical fiber link 16. The N-BER allows the QKD system users to establish the proper operating procedures and parameters (e.g., detector gating intervals, synchronization signal timing, mean-photon number per photon pulse, etc.) for QKD system operation. However, a lengthy N-BER calculation also prevents quick set-up and calibration of a commercial QKD system, particularly when a new BER measurement is needed after each adjustment.

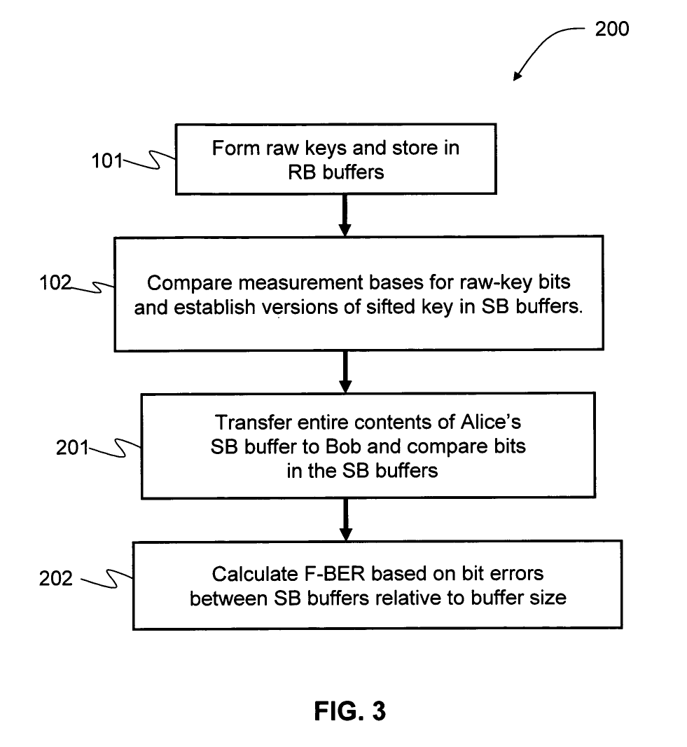

Accordingly, the present invention includes a F-BER calculation mode. FIG. 3 is a flow diagram 200 of an example embodiment of an F-BER calculation method according to the present invention. The F-BER calculation method 200 starts with the same acts 101 and 102 of the N-BER calculation method of FIG. 2, in which Alice and Bob establish a raw bits in their respective RB buffers 44A and 44B (that form a “raw key”), and then a sifted key in their respective SB buffers 50A and 50B. Again, there are actually two different versions of the sifted keys—one in SB buffer 50A at Alice and another in SB buffer 50B at Bob.

In an example embodiment, the SB buffer size (i.e., the number of sifted bits used) in the F-BER mode is about 100 Bytes, while for the N-BER mode, the SB buffer is filled to 8K Bytes before error-correction is performed. In an example embodiment, the size of SB buffers 50A and 50B in F-BER mode is defined by a single set of raw bits in the respective RB buffers 44A and 44B. Using less space in the SB buffer in F-BER mode further speeds up the BER calculation.

Now, in the N-BER mode (FIG. 2), at this point Alice and Bob would each perform their own error-correction on a number of SB buffers per acts 103 and 104, with only the necessary information to perform the error-correction algorithm being sent between the Alice and Bob. However, in the F-BER mode, in 201 all the data in Alice's SB buffer 50A is sent to Bob for the F-BER calculation. The F-BER calculation is performed at Bob on the entire amount of bits in the SB buffers. Bob then compares his version of the sifted key against Alice's. Differences in sifted-key bits between Alice and Bob are bit errors. The number of bit errors divided by the total number of sifted-key bits making up the sifted key gives the F-BER. It should be mentioned here that in another example embodiment of the F-BER calculation method, Bob sends his SB buffer date-data to Alice and Alice performs the F-BER calculation. It is not material which QKD station actually performs the F-BER calculation.

In determining the F-BER, the system does not perform error-correction, or carry out further processing such as privacy amplification, and no quantum keys are generated. In other words, the F-BER calculation does not rely on having to carry out the error correction process.

A disadvantage of running the QKD system in the F-BER mode is that calculating the F-BER using a relatively small SB buffer size as compared to the N-BER mode leads to a somewhat larger fluctuation in F-BER measurements as compared to the N-BER measurements. In other words, the N-BER calculation method provides a more accurate measurement of the BER that users would actually experience in the key-exchange process. Also, the bits generated in the F-BER mode are not useful for forming a key and are discarded. However, the advantages of using the F-BER mode outweighs accuracy considerations because the F-BER calculation is used for QKD system start-up and calibration, rather than to monitor normal QKD system operation. Further, the F-BER mode can operate on buffers as small as 10-100 bits, thus making the F-BER mode 100× to 1000× faster than the N-BER mode. Thus, when the N-BER mode takes about 20 minutes, the F-BER mode can take about 1 second.

Also, the F-BER is generated at the same rate as it takes to fill SB buffers 50A and 50B, thereby providing for fast periodic updates of the F-BER. A QKD system user can therefore quickly verify system performance by assessing the SPD counts level and the F-BER. Further, since no secure bits are generated in the F-BER mode, the optical power in the optics layer can be increased, e.g., the mean photon number of weak coherent pulses (WCPs) can be made higher than that normally used for the quantum signals exchanged to form the quantum key.

A slight increase in the quantum signal strength generally does not significantly affect the F-BER, unless the quantum signal power is so low that number of counts due to the signal is comparable to that of dark counts. In latter case, the change in BER with signal strength can be determined empirically to allow for an estimation of the F-BER at weaker quantum signal strengths. Thus, an example embodiment of the invention includes increasing the mean photon number of the quantum signals in the F-BER relative to that used in the normal operating mode in order to more quickly determine a value for the F-BER.

QKD system 10 can be easily switched between the F-BER and N-BER modes. This is especially useful for establishing a normal operating mode after a successful initial calibration, or for switching back to the F-BER mode for recalibration. Recalibration is often necessary when there is a modification to the QKD system, such as when a QKD system component is changed, or the length of the optical fiber link changes.

While the present invention has been described in connection with preferred embodiments, it will be understood that it is not so limited. On the contrary, it is intended to cover all alternatives, modifications and equivalents as may be included within the spirit and scope of the invention as defined in the appended claims.

1. A method of calculating a fast bit-error rate (F-BER) in an F-BER mode of a quantum key distribution (QKD) system that has first and second QKD stations and a normal bit-error rate (N-BER) in an N-BER mode, comprising:
establishing first and second versions of a sifted key in respective first and second sifted-bits (SB) buffers in the respective first and second QKD stations, the sifted key having a length;
transferring the first version of the sifted key in the first SB buffer in the first QKD station to the second QKD station; and
at the second QKD station, comparing the first and second versions of the sifted key to identify a number of bit errors relative to the sifted key length to establish the F-BER, wherein the F-BER mode does not include error correction and is operated at a rate between 100× and 1000× faster than the N-BER mode that includes error correction.

2. The method of claim 1, wherein the QKD system includes a normal operating mode and a calibration mode, and further comprising using the F-BER in the calibration mode.

3. The method of claim 1, further comprising switching between the F-BER mode and the N-BER mode.

4. The method of claim 1, wherein a first number of sifted key bits used in the F-BER mode is less than a second number of sifted bits used in the N-BER mode.

5. (canceled)

6. The method of claim 1, including repeatedly clearing and filling the first and second SB buffers to repeatedly calculate the F-BER.

7. The method of claim 1, wherein the N-BER mode calculates the N-BER by carrying out the error correction using an error-correction algorithm based on exchanging quantum signals have first mean photon number, and further including operating the QKD system in the F-BER mode and calculating the F-BER using quantum signals having a second mean photon number that is greater than the first mean photon number.

8. A method of calculating a fast bit-error rate (F-BER) in a quantum key distribution (QKD) system that has first and second QKD stations, comprising:
establishing in the first and second QKD stations respective first and second versions of a sifted key having a length;
sending the first version of the sifted key to the second QKD station;
comparing the first and second versions of the sifted key to establish a number of bit errors without performing error correction;
establishing the F-BER by dividing the number of bit errors by the sifted-key length: and
not using the first and second sifted keys to form a subsequent key.

9. The method of claim 8, including storing the first and second sifted-key versions in respective sifted-bits (SB) buffers in the first and second QKD stations.

10. The method of claim 8, including making adjustments to the QKD system and then calculating the F-BER after each adjustment.

11. The method of claim 8, wherein the QKD system has a normal BER (N-BER) mode that calculates a normal BER (N-BER) by carrying out an error-correction algorithm based on exchanging quantum signals have first mean photon number, and further including operating the QKD system in an F-BER mode that calculates the F-BER using quantum signals having a second mean photon number that is greater than the first mean photon number.

12. The method of claim 4, wherein the number of sifted bits in the F-BER mode differs from that of the N-BER mode by about a factor of about eight.

13. The method of claim 1, further comprising forming the sifted key to have up to 100 bytes.

14. The method of claim 13, further comprising forming the sifted key to have between 10 and 100 bits.

15. The method of claim 8, further comprising forming the sifted key to have up to 100 bytes.

16. The method of claim 15, further comprising forming the sifted key to have between 10 and 100 bits.

17. The method of claim 4, wherein the QKD system includes a normal bit-error rate (N-BER) mode, and further comprising using a number of sifted bits in the F-BER mode that is about eight times less than in the N-BER mode.
